(19) United States
(12) Patent Application Publication
(10) Pub. No.: US 2025/0315429 A1
(43) Pub. Date: Oct. 9, 2025

(54) DIALOGUE SYSTEM

(71) Applicant: TOYOTA JIDOSHA KABUSHIKI KAISHA, Toyota-shi (JP)

(72) Inventor: Hideki KAWAI, Tokyo (JP)

(73) Assignee: TOYOTA JIDOSHA KABUSHIKI KAISHA, Toyota-shi (JP)

(21) Appl. No.: 19/057,548

(22) Filed: Feb. 19, 2025

(30) Foreign Application Priority Data
Apr. 4, 2024 (JP) 2024-060794

(51) Int. Cl. G06F 16/245

(52) U.S. Cl. CPC G06F 16/245

(57) ABSTRACT

A dialogue system is provided with a designator configured to designate a database to be used in a search from a plurality of databases on the basis of a use's query, a generator configured to generate a prompt to be input to a generative AI on the basis of a search result of a search using the designated database and the query, and an outputter configured to output an output of the generative AI in response to the prompt as an answer to the query.

### CROSS-REFERENCE TO RELATED APPLICATIONS

This application is based upon and claims the benefit of priority of the prior Japanese Patent Application No. 2024-060794, filed on Apr. 4, 2024, the entire contents of which are incorporated herein by reference.

### BACKGROUND

### 1. Technical Field

The present invention relates to a dialogue system.

### 2. Description of the Related Art

As a technique used in this type of system, for example, a method has been proposed that includes inputting an initial input determined based on input data from a user to a deep learning model, and finalizing a second input to be input to the deep learning model based on the initial input and a first intermediate result (see Patent Literature 1: Japanese Patent Application Laid Open No. 2023-182707).

When a generative AI (Artificial Intelligence) is used in a dialogue system, a hallucination, in which a generative AI outputs a content that is different from facts or that is unrelated to context, is a problem. In response to this problem, a technology called RAG (Retrieval Augmented Generation) has been proposed that combines a generative AI with a search system to generate answers that reflect specialized knowledge and the latest knowledge. However, even if a product has the same name, specifications may differ depending on the year of manufacture, for example. For this reason, even if the RAG is used, there is a technical problem that answers to inquiries about the product may be inaccurate.

### SUMMARY

In view of the problem described above, it is therefore an object of the present invention to provide a dialogue system which can improve accuracy of answers.

### BRIEF DESCRIPTION OF THE DRAWINGS

FIG. 1 is a block diagram illustrating configuration of a dialogue system of a first embodiment.

FIG. 2 is a flowchart illustrating operation of the dialogue system of the first embodiment.

FIG. 3 is a block diagram illustrating configuration of a dialogue system of a second embodiment.

FIG. 4 is a flowchart illustrating operation of the dialogue system of the second embodiment.

FIG. 5 is a block diagram illustrating configuration of a dialogue system of a third embodiment.

FIG. 6 is a flowchart illustrating operation of the dialogue system of the third embodiment.

### DETAILED DESCRIPTION OF THE EMBODIMENT

### First Embodiment

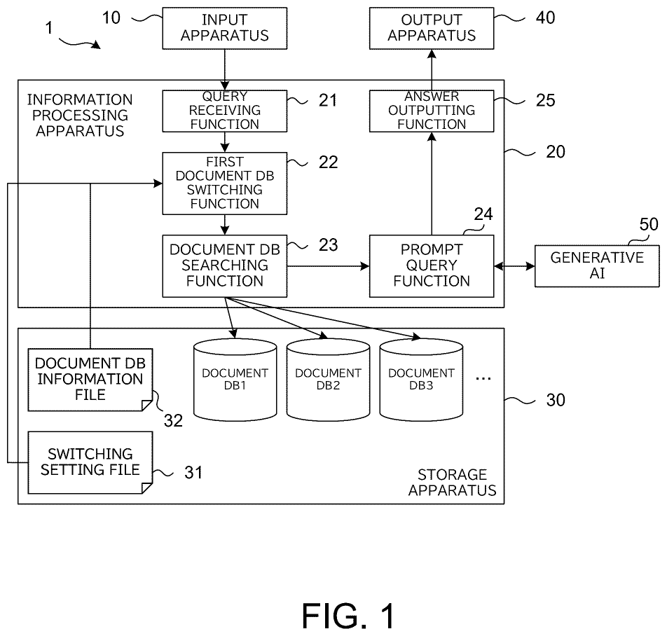

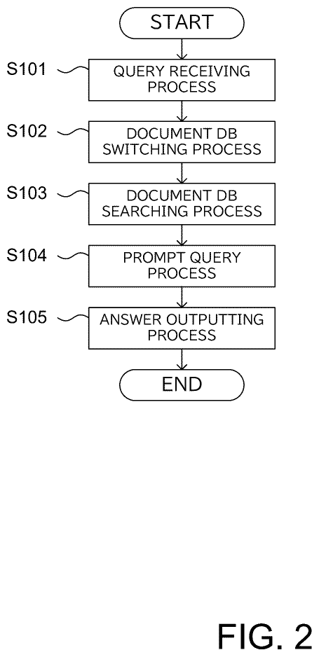

A first embodiment of a dialogue system will be described with reference to FIGS. 1 and 2. In FIG. 1, the dialogue system 1 is provided with an input apparatus 10, an information processing apparatus 20, a storage apparatus 30, an output apparatus 40 and a generative AI 50. The input apparatus 10 is, an apparatus operable by a user such as a keyboard, a mouse, a touch panel, a microphone, or the like, for example. The information processing apparatus 20 may include a CPU (Central Processing Unit), a GPU (Graphics Processing Unit, and the like, for example. The information processing apparatus 20 may further include a RAM (Random Access Memory), a ROM (Read Only Memory, and the like, for example. The storage apparatus 30 may include a recording medium such as a hard disk apparatus, an SSD (Solid State Drive), or the like, for example. The output apparatus 40 is an apparatus capable of outputting information to the outside of the information processing apparatus 20 such as a display, a speaker and the like, for example.

The generative AI 50 may be configured to be available through a network, such as the Internet. In other words, the generative AI 50 may be provided as a cloud service. The generative AI 50 may be configured to be executable by an apparatus after being downloaded to the apparatus that is directly operable by a user, such as a personal computer.

The information processing apparatus 20 may be a personal computer, for example. In this case, the information processing apparatus 20 and the storage apparatus 30 may be accommodated in the same housing. However, the storage apparatus 30 may be an apparatus connected to the information processing apparatus 20 via a network, such as a network drive. Incidentally, for example, as a notebook-type personal computer or the like, the input apparatus 10, the information processing apparatus 20, the storage apparatus 30 and the output apparatus 40 may be accommodated in the same housing. The information processing apparatus 20 may be implemented by a server apparatus (e.g., a cloud server). In this case, the input apparatus 10 and the output apparatus 40 may be realized by a terminal apparatus capable of communicating with the information processing apparatus 20 (for example, a personal computer, a tablet terminal, a smartphone, or the like).

The information processing apparatus 20 has a query receiving function 21, a first document DB (DataBase) switching function 22, a document DB 23, a prompt query function 24 and an answer outputting function 25. The storage apparatus 30 has a plurality of document DB (e.g., document DB1, document DB2, document DB3, . . . ). The storage apparatus 30 further has a switching setting file 31 and a document DB information file 32.

In the following, it will be specifically described when the dialog system 1 answers the user's query about the vehicle. The query receiving function 21 of the information processing apparatus 20 accepts the user's query entered via the input apparatus 10 as text data. In addition, when the user inputs a query through the microphone as an exemplary input apparatus 10 (in other words, in the case of voice input), the query receiving function 21 may generate text data of the query based on the voice data of the query. The query receiving function 21 outputs the text data to the first document DB switching function 22.

The first document DB switching function 22 detects a keyword indicating, for example, a vehicle type, a driving system or the like from the above-mentioned text data. The first document DB switching function 22 identifies the regular expressions of the detected keywords by referring to the switching setting file 31 of the storage apparatus 30. Regular expressions are one of the expressions used for pattern matching of strings. The switching setting file 31 will be described with reference to Table 1. As shown in Table 1, the switching setting file 31 specifies correlation between regular expressions and synonyms. For example, the regular expressions of “ [symbol] , [symbol] [symbol] [symbol] (registered trademark)” and “Prius (registered trademark)” are the “vehicle type T1”. For example, the regular representations of “HEV”, “HV” and “hybrids” are the “drive scheme V1”.

TABLE 1

| | |
|---|---|
| Regular representation | Synonym List |
| Vehicle Type T1 | [symbol] [symbol] [symbol] [symbol] Prius |
| Vehicle Type T2 | [symbol] [symbol] [symbol] [symbol] [symbol] [symbol] |
| | [symbol] [symbol] [symbol] [symbol] [symbol] [symbol] |
| | [symbol] [symbol] [symbol] [symbol] [symbol] [symbol] [symbol] |
| | [symbol] [symbol] [symbol] [symbol] [symbol] [symbol] [symbol] Velfire |
| Vehicle Type T3 | [symbol] [symbol] [symbol] [symbol] |
| | [symbol] [symbol] [symbol] [symbol] [symbol] Voxy |
| Driving system V1 | HEV, HV, Hybrid |
| Driving system V2 | PHEV, PHV, Plug-in hybrid |
| Driving system V3 | CV, Internal combustion engine, Convex |

For example, the user's query may be “What is the type of battery of the smart key of the Prius PHEV of 2018 model?” In this case, the first document DB switching function 22 may detect “Prius” and “PHEV” as keywords from the query as text data. The first document DB switching function 22 may specify the “vehicle type T1” which is a regular expression of “Prius” and the “driving system V2” which is a regular expression of “PHEV” referring to the switching setting file 31. Note that the “2018 model” is a regular expression related to the annual model.

The first document DB switching function 22 specifies the document DB to be used for search from a plurality of document DB based on the regular expression and the document DB information file 32 of the storage apparatus 30. The document DB info file 32 will be described with reference to Table 2. As shown in Table. 2, the document DB data file 32 defines a relationship among a combination of the vehicle type, the driving system and the annual formula, the document, and the document DB related to the document. Here, product manuals and product catalogs are cited as examples of documents. The document is not limited to the product manual and the product catalog, the document may be a main specification table, a function operation guide, a multimedia handling manual, a maintenance procedure manual, or the like, for example. In the document listing of the document DB file 32, not only the file name which indicates the electronic data related to the document but also URL (Uniform Resource Locator) in which the document is published may be registered.

TABLE 2

| Vehicle | Driving | Annual | | Document |
|---|---|---|---|---|
| type | system | model | Document list | DB |
| T1 | V1 | 2018 | T1_V1_2018_manual.pdf, T1_V1_2018_catalog.pdf | DB1 |
| | | 2023 | T1_V1_2023_manual.pdf, T1_V1_2023_catalog.pdf | DB2 |
| | V2 | 2018 | T1_V2_2018_manual.pdf, T1_V2_2018_catalog.pdf | DB3 |
| | | 2023 | T1_V2_2023_manual.pdf, T1_V2_2023_catalog.pdf | DB4 |
| T2 | V1 | 2010 | T2_V1_2010_manual.pdf, T2_V1_2010_catalog.pdf | DB5 |
| | | 2015 | T2_V1_2015_manual.pdf, T2_V1_2015_catalog.pdf | DB6 |
| | | 2018 | T2_V1_2018_manual.pdf, T2_V1_2018_catalog.pdf | DB7 |
| T3 | V2 | 2018 | T3_V2_2018_manual.pdf, T3_V2_2018_catalog.pdf | DB8 |
| | | 2023 | T3_V2_2023_manual.pdf, T3_V2_2023_catalog.pdf | DB9 |
| | V3 | 2018 | T3_V3_2018_manual.pdf, T3_V3_2018_catalog.pdf | DB10 |

For example, when the user's query is “What is the type of the battery of the smart key of the Prius PHEV of 2018 model?”, the first document DB switching function 22 may specify a document DB3 as a DB to be used for searching based on the regular expressions the “vehicle type T1”, the “drive system V2” and the “2018 model” and the document DB data file 32. The first document DB switching function 22 outputs to the document DB searching function 23 information indicating the specified document DB (e.g., the document DB3). When the first document DB switching function 22 outputs the specified document DB to the document DB searching function 23, the first document DB switching function 22 can be regarded as specifying the document DB to be searched by the document DB searching function 23.

The document DB searching function 23 searches the document DB specified by the first document DB switching function 22 referring to the user's query. The document DB searching function 23 may perform a vector search. A plurality of document DBs (e.g., the document DB1, the document DB2, the document DB3, . . . ) may each include a vector index, such that the document DB retrieval function 23 can perform a vector search at high speed. In this case, documents (e.g., product manuals, product catalogs, etc.) may be vectorized. By vectorizing the document, vector data may be generated. Vector indexing may mean a mechanism for efficiently retrieving vectorized documents (i.e., vector data) contained in every document DB. Incidentally, since the existing various aspects can be applied to the method of vectorizing the document, a description the method of vectorizing in detail will be omitted. For example, the document DB retrieval function 23 may vectorize the user's queries (i.e., documents). The document DB searching function 23 may determine the cosine similarity between the vectorized query and the vectorized document included in the document DB specified by the first document DB switching function 22. The document DB searching function 23 may search documents (or, in other words, informational) related to the user's query based on cosine similarity. The document DB searching function 23 outputs search results to the prompt query function 24.

The prompt query function 24 creates a prompt to be entered in the generative AI 50 based on the search result by the document DB searching function 23 and the user's query. An example of a prompt created by the prompt query function 24 will be specifically described. Prompts may include instructions, prerequisite knowledge and queries. For example, the instruction may include the roles of the generative AI 50 and processing content. The prerequisite knowledge may include search results by document DB searching function 23. A query is a user's query. The user's query may be: “What is the type of the battery of the smart key of the Prius PHEV of the 2018 model?” The search result by the document DB searching function 23 may be “the countermeasure when the Prius smart key becomes ineffective”, “the smart key battery replacement (lithium battery CR2032)” and “the door unlock method using the smart key”. In this case, the prompt query function 24 may create a prompt such as the following.

### Instructions

You are an excellent sales staff of a Toyota dealer.

Create a response to “Query: ” based on “Prerequisite knowledge: ” below.

### Prerequisite Knowledge

Search result 1: the countermeasure when the Prius smart key becomes ineffective.

Search result 2: the smart key battery replacement (lithium battery CR2032).

Search result 3: the door unlock method using the smart key.

### Query

What is the type of the battery of the smart key of the Prius PHEV of 2018 model?

In the above instructions, one of the roles of the generative AI 50 is “you are an excellent sales staff of a Toyota dealer”. In addition, one of processing content is “Create a response to “Query: ” based on “Prerequisite knowledge: ” below”.

The prompt query function 24 may acquire the answer of the generative AI 50 to the prompt (in other words, the output of the generative AI). The prompt query function 24 may output the answer of the generative AI 50 to the answer outputting function 25. Instead of the prompt inquiry function 24, the answer outputting function 25 may acquire the answer of the generative AI 50 to the prompt. The answer outputting function 25 transmits the answer of the generative AI 50 to the output apparatus 40. Consequently, the output apparatus 40 presents the user with an answer of the generative AI 50 as an answer to the user's query.

The operation of the dialogue system 1 will now be described with reference to the flowchart of FIG. 2. In FIG. 2, the query receiving function 21 of the information processing apparatus 20 performs the query receive processing that receives the user's query as text data (step S101). The first document DB switching function 22 of the information processing apparatus 20 performs the document DB switching processing to specify the document DB to be used for searching from the plurality of document DB based on the text data (in other words, the user's query) received in processing of the step S101 (step S102). The document DB searching function 23 of the information processing apparatus 20 performs the document DB searching processing to search the document DB specified in processing of the step S102 (step S103). The prompt query function 24 of the information processing apparatus 20 performs a prompt query processing based on the result of processing of the step S103 (i.e., the search result of the document DB searching function 23) and the user's query to create a prompt to enter in the generative AI 50 (step S104). The answer outputting function 25 of the information processing apparatus 20 performs the answer outputting processing in which the answer of the generative AI 50 to the prompt is sent to the output apparatus 40 (step S105).

### Technical Effect

For example, “CR2032” is the correct answer for the Prius of the 2018 model, while “CR2450” is the correct answer for the Prius of the 2023 model, regarding the query “What is the type of the battery of the smart key of Prius?”. Thus, even in the same query, the answers may be different if the products are different. Even in a system, for example, where the RAG is used, it is difficult for the system to answer a query correctly if an appropriate source is not searched. In contrast, in the dialog system 1 according to the present embodiment, the first document DB switching function 22 specifies a document DB to be used for searching from a plurality of document DB. The document DB searching function 23 then searches the specified document DB. Thus, in the dialogue system 1, the document DB (i.e., information sources) suitable for the user's queries are searched. Therefore, according to the dialog system 1, it is possible to improve the accuracy of the answer to the user's query.

### Modified Example

A user's query may not include at least one of “driving system” and “annual model”. Therefore, the initial values of the “drive system” and “annual model” may be set in advance. For example, the initial value of the “drive system” may be the most drive system of the number of units sold. For example, the initial value of the “annual model” may be the annual model of the latest model. According to this structure, even when at least one of the driving system and the annual model is not included in the user's query, the first document DB switching function 22 can specify the document DB to be used for searching.

### Second Embodiment

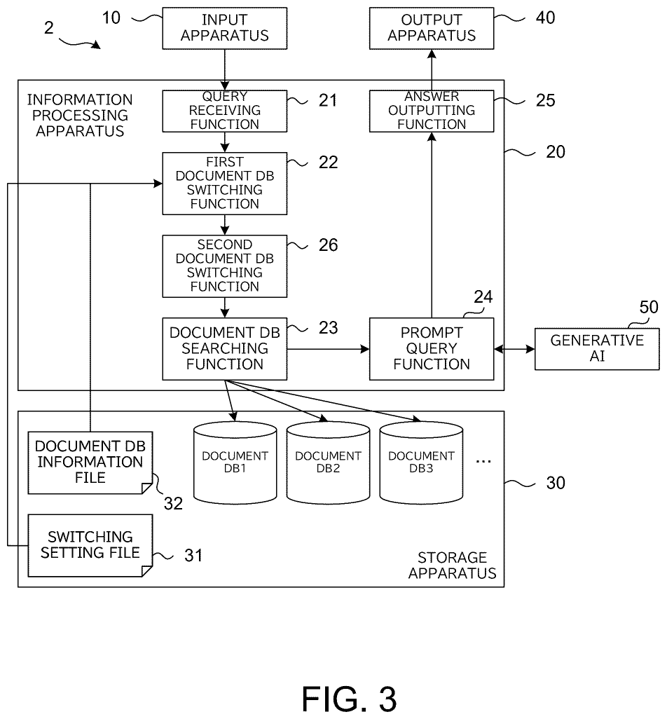

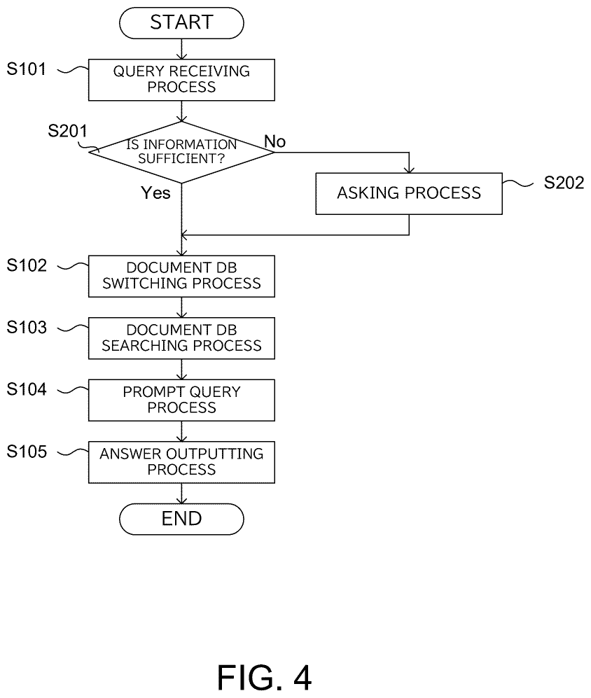

A second embodiment of the dialogue system will be described with reference to FIGS. 3 and 4. The dialogue system 2 according to the second embodiment is the same as the dialogue system 1 according to the first embodiment except that a part of the configuration of the information processing apparatus 20 differs. Therefore, for the second embodiment, the description overlapping with the description of the first embodiment will be omitted as appropriate. Further, like reference numerals denote parts common to the first embodiment in the drawings.

In FIG. 3, the dialogue system 2 includes an input apparatus 10, an information processing apparatus 20, a storage apparatus 30, an output apparatus 40 and a generative AI 50. The information processing apparatus 20 has a query receiving function 21, a first document DB switching function 22, a document DB 23, a prompt query function 24, a answer outputting function 25 and a second document DB switching function 26.

For example, as shown in Table 2, the document DB data file 32 of the storage apparatus 30 may specify a relationship among a combination of the vehicle type, the driving system and the annual model, the document, and the document DB relating to the document. If the user's query does not include at least one of the vehicle type, the driving method and the annual model, the first document DB switching function 22 may be difficult to identify the document DB to be used for searching.

If the user's query lacks data (for example, at least one of a vehicle type, a driving system, and an annual equation) for specifying a document DB to be used for searching, the second document DB switching function 26 may perform an asking the user again. The “asking the user again” may be paraphrased as “request for additional information to the user”.

For example, if the user's query is “What is the type of the battery of the smart key of the Prius?”, the driving system and the annual model are unknown. In other words, in this case, the “driving system” and the “annual model” as information for specifying the document DB used for searching are unknown. In this case, the second document DB switching function 26 may perform an asking “Is the driving system HEV or PHEV?” and “When is the annual model?”.

When the user answers to the asking by the second document DB switching function 26, the first document DB switching function 22 may specify the document DB to be used for searching based on the user's query and the user's answer (i.e., additional information). Specifically, the first document DB switching function 22 may detect keywords from each of the user's query and the user's answer. The first document DB switching function 22 may identify the regular expressions of the detected keywords by referring to the switching setting file 31 of the storage apparatus 30. The first document DB switching function 22 may specify the document DB to be used for searching from a plurality of document DB based on the regular expression and the document DB information file 32 of the storage apparatus 30.

The operation of the dialogue system 2 will now be described with reference to the flowchart of FIG. 4. In FIG. 4, after processing of the step S101, it is determined whether or not the user's query contains enough information for specifying the document DB to be used for searching (step S201). The processing of the step S201 may be performed by the first document DB switching function 22 or may be performed by the second document DB switching function 26.

If it is determined in the processing of the step S201 that the user's query includes enough information to identify the document DB to be searched (step S201: Yes), processing of the step S102 is performed. On the other hand, in processing of the step S201, when it is determined that the user's query does not sufficiently contain the information to identify the document DB to be used for searching (step S201: No), the second document DB switching function 26 performs the asking again processing for asking the user (step S202). After processing of the step S202 is performed, if the user answers to the asking, processing of the step S102 is performed.

### Technical Effect

In the dialog system 2 according to the present embodiment, when the information for specifying the document DB to be used for searching is insufficient for the user's query, the second document DB switching function 26 asks the user. The first document DB switching function 22 may specify the document DB to be used for searching based on the user's query and the user's answer to the asking. With this arrangement, the document DB used for searching can be appropriately identified. Therefore, according to the dialogue system 2, it is possible to improve the accuracy of the answer to the query of the user.

### Third Embodiment

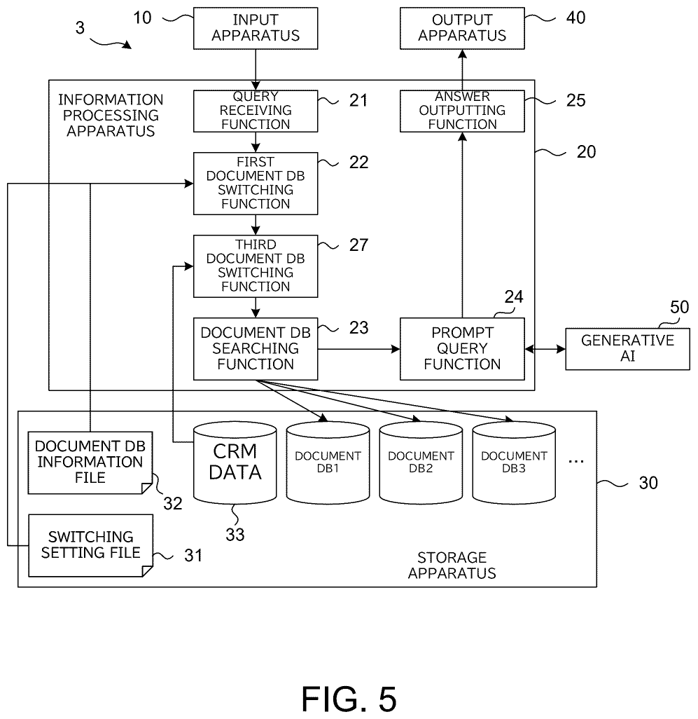

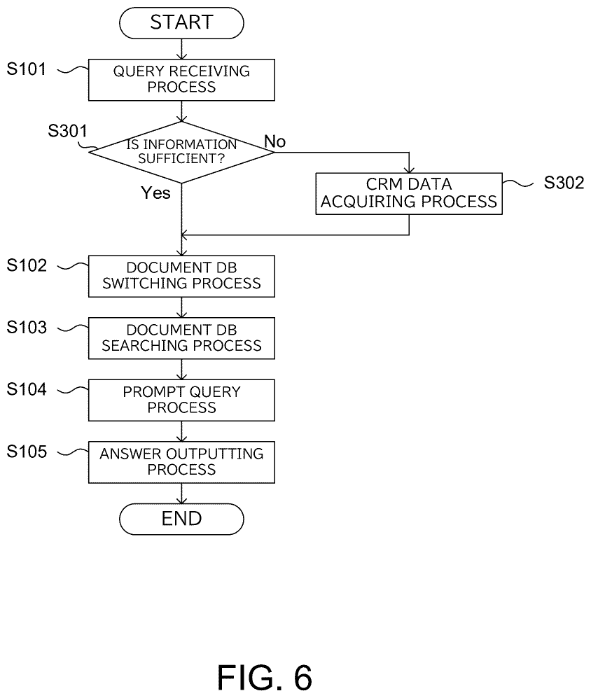

A third embodiment of the dialogue system will be described with reference to FIGS. 5 and 6. The dialog system 3 according to the third embodiment is the same as the dialog system 1 according to the first embodiment except that a part of each configuration of the information processing apparatus 20 and the storage apparatus 30 is different. Therefore, for the third embodiment, the description overlapping with the description of the first embodiment will be omitted as appropriate. Further, like reference numerals denote parts common to the first embodiment in the drawings.

In FIG. 3, the dialogue system 3 includes an input apparatus 10, an information processing apparatus 20, a storage apparatus 30, an outputting apparatus 40 and a generative AI 50. The information processing apparatus 20 has a query receiving function 21, a first document DB switching function 22, a document DB 23, a prompt query function 24, a answer outputting function 25 and a third document DB switching function 27. The storage apparatus 30 includes a plurality of document DB, a switching setting file 31, a document DB information file 32, and a CRM (Customer Relationship Management) data 33. Information about the user is registered in the CRM data 33.

For example, as shown in Table 2, the document DB data file 32 of the storage apparatus 30 may specify a relationship among the combination of the vehicle type, the driving system and annual model, the document, and the document DB relating to the document. If the user's query does not include at least one of the vehicle type, the driving system and the annual model, the first document DB switching function 22 may be difficult to identify the document DB to be used for searching.

If there is insufficient information (for example, at least one of the vehicle type, the driving system, and the annual equation) for specifying the document DB to be used for searching in the query of the user, the third document DB switching function 27 may acquire information about the user from the CRM data 33. The third document DB switching function 27 may acquire supplemental information as information for identifying the document DB to be used for searching from the acquired information.

The first document DB switching function 22 may specify the document DB to be used for searching based on the user's queries and supplementary information acquired by the third document DB switching function 27. Specifically, the first document DB switching function 22 may detect keywords from each of the user's queries and supplementary information. The first document DB switching function 22 may identify the regular expressions of the detected keywords by referring to the switching setting file 31 of the storage apparatus 30. The first document DB switching function 22 may specify the document DB to be used for searching from a plurality of document DB based on the regular expression and the document DB information file 32 of the storage apparatus 30.

The operation of the dialogue system 3 will now be described with reference to the flowchart of FIG. 6. In FIG. 6, after processing of the step S101, it is determined whether or not the user's query contains enough information for specifying the document DB to be used for searching (step S301). The processing of the step S301 may be performed by the first document DB switching function 22 or may be performed by the third document DB switching function 27.

If it is determined in the processing of the step S301 that the user's query includes enough information to identify the document DB to be searched (step S301: Yes), processing of the step S102 is performed. On the other hand, in the step S301, when it is determined in processing that the user's query does not sufficiently contain information to identify the document DB to be used for searching (step S301: No), the third document DB switching function 27 performs the CRM data acquisition processing to acquire supplementary information from the CRM data 33 of the storage apparatus 30 (step S302). Then, processing of the step S102 is performed.

### Technical Effect

In the dialog system 3 according to the present embodiment, when the information for specifying the document DB to be used for searching is insufficient for the user's query, the third document DB switching function 27 acquires supplementary information from the CRM data 33. The first document DB switching function 22 may specify the document DB to be used for searching based on the user's queries and supplementary information. With this arrangement, the document DB used for searching can be appropriately identified. Therefore, according to the dialogue system 3, it is possible to improve the accuracy of the answer to the query of the user.

In the embodiment described above, an automobile as an example of a product, the product may be, for example, software of a computer, hardware of a computer, or the like. If the product is software, the document DB information file 32 may specify a combination of the application name, corresponding OS (Operating System), and version number, as well as a correlation between the document (e.g., software usage manual, user's guide, specification, etc.) and the document DB associated with the document.

Aspects of the invention derived from the embodiments and modified examples described above will be described below.

One aspect of a dialogue system of the present invention is a dialogue system comprising: a designator configured to designate a database to be used in a search from a plurality of databases on the basis of a use's query, a generator configured to generate a prompt to be input to a generative AI on the basis of a search result of a search using the designated database and the query, and an outputter configured to output an output of the generative AI in response to the prompt as an answer to the query. In the above-described embodiment, the “first document DB switching function 22” corresponds to an example of the “designator”, the “prompt query function 24” corresponds to an example of the “generator” and the “answer outputting function 25” corresponds to an example of the “outputter”.

The dialogue system may further comprise a requester configured to request additional information to the user when the query lacks information for designating a database to be used in the search. In this case, the designator may designate the database to be used in the search on the basis of the query and the additional information. In the above-described embodiment, the “second document DB switching function 26” corresponds to an example of the “requester”.

The dialogue system may further comprise an acquirer configured to acquire supplementary information from use information related to the user that has been registered in advance when the query lacks information for designating a database to be used in the search. In this case, the designator may designate the database to be used in the search on the basis of the query and the supplementary information. In the above-described embodiment, the “third document DB switching function 27” corresponds to an example of the “acquirer”.

In the dialogue system, each of the plurality of databases may include vector data in which a character string indicating a document is vectorized.

The present invention is not limited to the above-described embodiments, but may be appropriately modified in range which is not contrary to the gist or the philosophy of the invention which can be read from range of the patent claims and the specification, and a dialogue system involving such modifications is also included in the technical range of the present invention.

1. A dialogue system comprising:
a designator configured to designate a database to be used in a search from a plurality of databases on the basis of a use's query;
a generator configured to generate a prompt to be input to a generative AI on the basis of a search result of a search using the designated database and the query; and
an outputter configured to output an output of the generative AI in response to the prompt as an answer to the query.

2. The dialogue system according to claim 1,
further comprising: a requester configured to request additional information to the user when the query lacks information for designating a database to be used in the search,
wherein the designator designates the database to be used in the search on the basis of the query and the additional information.

3. The dialogue system according to claim 1,
further comprising: an acquirer configured to acquire supplementary information from use information related to the user that has been registered in advance when the query lacks information for designating a database to be used in the search,
wherein the designator designates the database to be used in the search on the basis of the query and the supplementary information.

4. The dialogue system according to claim 1, wherein
each of the plurality of databases includes vector data in which a character string indicating a document is vectorized.

5. The dialogue system according to claim 2, wherein
each of the plurality of databases includes vector data in which a character string indicating a document is vectorized.

6. The dialogue system according to claim 3, wherein
each of the plurality of databases includes vector data in which a character string indicating a document is vectorized.
